(19) United States
(12) Patent Application Publication
(10) Pub. No.: US 2025/0382848 A1
(43) Pub. Date: Dec. 18, 2025

(54) ROBOTIC PIPE DOPE APPLICATION SYSTEM

(71) Applicant: NATIONAL OILWELL VARCO, L.P., Houston, TX (US)

(72) Inventor: Karl Bernhard Henriksen, Kristiansand (NO)

(21) Appl. No.: 19/103,058

(22) PCT Filed: Aug. 31, 2022
(86) PCT No.: PCT/US2022/075797

§ 371 Date: Feb. 11, 2025

(51) Int. Cl. E21B 17/00; B05C 1/02; B25J 9/16; B25J 15/00

(52) U.S. Cl. CPC E21B 17/006; B05C 1/02; B25J 9/1679; B25J 15/0019

(57) ABSTRACT

A pipe-dope application system can include an end effector including an applicator configured to retain pipe-dope for application to a drilling component surface, the end effector adapted for connection with a robotic arm configured to perform operations including: applying pipe-dope to the drilling component surface by moving the applicator along the drill pipe surface; and supplying pipe-dope to the applicator by positioning the applicator within a priming station configured to receive the applicator of the end effector.

### TECHNICAL FIELD

This document pertains generally, but not by way of limitation, to systems and methods for applying pipe-dope to threaded portions of drill pipes used in oil or gas drilling operations. More particularly, this document pertains, but not by way of limitation, to systems and methods for robotically applying pipe dope to both male portions and female portions of threaded connections formed between drill pipes or other drilling tools.

### BACKGROUND

Drilling operations for oil, gas, or other fossil fuels can involve threadedly connecting lengths of tubular drill pipe, or other threaded drilling tools, to one another For example, during tripping of a drill string, threadedly connected lengths of tubular drill pipe can be lowered into (tripping in) a well. The tripping in process involves threadedly connecting many separate lengths of tubular drill pipe or stands to increase the length of the drill string extending into the well, such as by threadedly engaging a box end (female portion) of a first length of drill pipe with a pin end (male portion) of a second length of drill pipe. In order to prevent fluids or gases from leaking through the threaded connections of the drill string, a sealing compound (pipe-dope), may be applied to both the box end and the pin end Pipe-doping operations have conventionally been performed by human operators.

Application of pipe-dope to the box ends and the pin ends of drill pipes has conventionally been performed by a drill floor worker, such as by using a brush periodically dipped into a bucket of pipe-dope. The brush and the bucket are often exposed to the elements during both use and storage, which can increase the probability of pipe dope contamination. Further, the quality of pipe-dope application can vary significantly from worker to worker, which can increase the risk of insufficient pipe dope application. Pipe dope contamination or insufficient pipe dope application can lead to the development of costly and time-consuming leaks or seizing of threaded connections of the drill string. Additionally, pipe doping operations are typically performed in a high-risk area of a drilling rig often referred to as the “red zone”. The red zone poses a significant threat to worker safety due to the presence of operational heavy machinery, some of which may change position frequently and without warning. As a result, some automated systems for performing pipe-doping operations have been implemented in order to limit worker presence in the red zone. However, such systems include a number of drawbacks.

For example, some existing pipe doping systems spray pipe dope onto drill pipe at high pressure using precise air atomizing nozzles. However, high-pressure spray systems can be costly and complex to operate, such by requiring the installation and monitoring of numerous support subsystems. Further, high-pressure spray systems can jeopardize reliability, such as by being vulnerable to nozzle clogging or pump failure in low temperature conditions, or as a result of contaminants in the pipe dope. Additionally, high-pressure spray systems can limit versatility, as some pipe dope types are not suited for high pressure spraying.

Other existing pipe-doping systems utilize a rotating applicator to apply pipe dope via contact with drill pipes to avoid some of the issues associated with high-pressure spray systems. However, the rotating applicators of such systems are typically fixed in position relative to the drill pipes, and as such, are only suitable to apply pipe dope to a box end (female portion) of a drill pipe by inserting the rotating brush into the box end. Further, such systems can require several applicators to effectively apply pipe dope to drill pipes of varying dimensions.

### SUMMARY

In an example, a pipe-dope application system comprises an end effector including an applicator configured to retain pipe-dope for application to a drilling component surface. The end effector may be adapted for connection with or coupled to a robotic arm configured to perform one or more operations. The operations may include applying pipe-dope to the drilling component surface by controlling an orientation and position of the applicator relative to the drilling component surface. The operations may also include supplying pipe-dope to the applicator by positioning the applicator within a priming station configured to receive the applicator of the end effector to supply pipe-dope to the applicator.

In another example, a method of robotically applying pipe-dope to a drilling component surface may include using processing circuitry, controlling movement of a robotic arm to position an applicator of the robotic arm within a priming station for supplying pipe-dope. The method may also include using processing circuitry, controlling movement of the robotic arm to cause the priming station to supply pipe-dope to the applicator. The method may also include using processing circuitry, controlling movement of the robotic arm to move the applicator along the drilling component surface to apply pipe-dope to the drilling component surface.

### BRIEF DESCRIPTION OF THE DRAWINGS

FIG. 1A illustrates a side perspective view of a drilling rig including a robotic system, according to one or more examples.

FIG. 1B illustrates a perspective view of a robotic system with a pipe-dope application system, according to one or more examples.

FIG. 2A illustrates a side view of the example robotic pipe-dope application system of FIG. 1B with a priming station in a first position, according to one or more examples.

FIG. 2B illustrates a side view of the example robotic pipe-dope application system of FIG. 1B with a priming station in a second position, according to one or more examples.

FIG. 2C illustrates a side view of an example end effector of the robotic pipe-dope application system engaging a drill pipe engagement surface, according to one or more examples.

FIG. 2D illustrates a side view of the end effector engaging a drill pipe end surface, according to one or more examples.

FIG. 3A illustrates a cross-section view of the end effector positioned within a receptacle of the priming station, according to one or more examples.

FIG. 3B illustrates an isometric view of the receptacle for the priming station, according to one or more examples.

FIG. 4 illustrates a schematic diagram of an example pump system in fluid communication with the receptacle of the priming station, according to one or more examples.

FIG. 5 illustrates a cross-section view of an example robotic pipe-dope application system, according to one or more examples.

FIG. 6 illustrates an example method of robotically applying pipe-dope to a drilling component surface, according to one or more examples.

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

### DETAILED DESCRIPTION

The robotic pipe application system of the present disclosure can help to address the above issues, among others, such as by providing a robotic arm including an end effector capable of retaining an amount of pipe dope and a priming station capable of supplying an amount of pipe dope to the end effector. First, for example, the robotic arm can be programmed or otherwise configured to autonomously move an applicator of the end effector along various drilling component surfaces, such as along a threaded portion of both a box end and a pin end of drill pipes of various sizes and having a taper. This can allow the robotic pipe dope application system to utilize a single universal applicator to apply pipe dope to drilling component surfaces defining various lengths, tapers, diameters, or other dimensions without the use of spray nozzles.

Second, for example, the robotic arm can be programmed or otherwise configured to autonomously position the applicator of the end effector within a receptacle of a priming station to cause the priming station to deliver pipe dope to the applicator. For example, the robotic arm can be configured to move a receptacle of the priming station from a first position to a second position to cause an amount of pipe dope to be pumped into the receptacle and onto the applicator at low pressure, such as from a sealed remote reservoir. This can eliminate the need for high-pressure pumps or other complex support equipment and prevent contamination of pipe dope during use or storage.

Some examples of the present system may also be considered passive by avoiding the need for high pressure air, electric motors, hydraulics, or other power sources apart from a robotic arm. That is, in one or more examples, other than a mobile end effector on the robot and a pressurized reservoir of pipe dope, no other power source may be utilized to apply pipe dope to drill pipe.

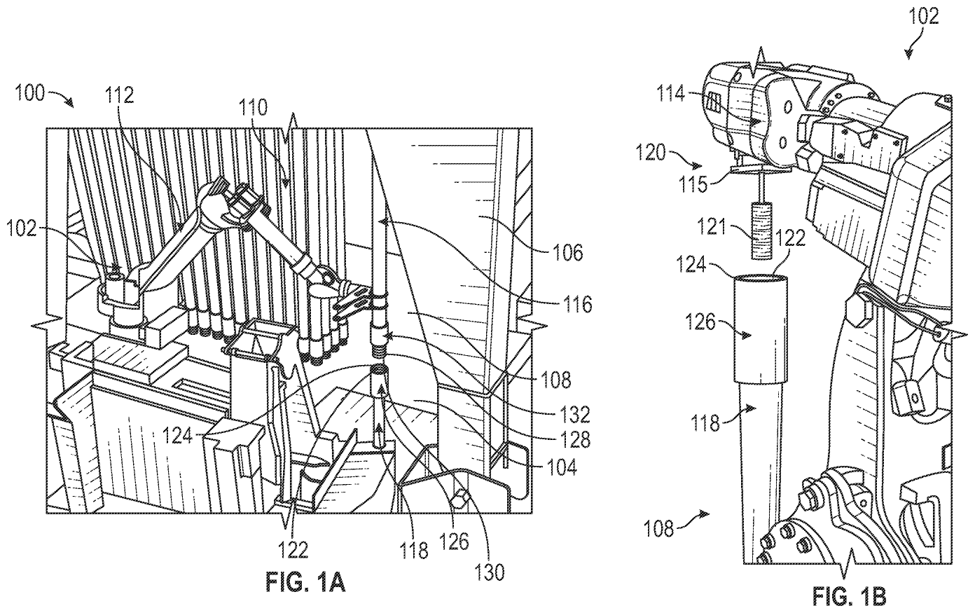

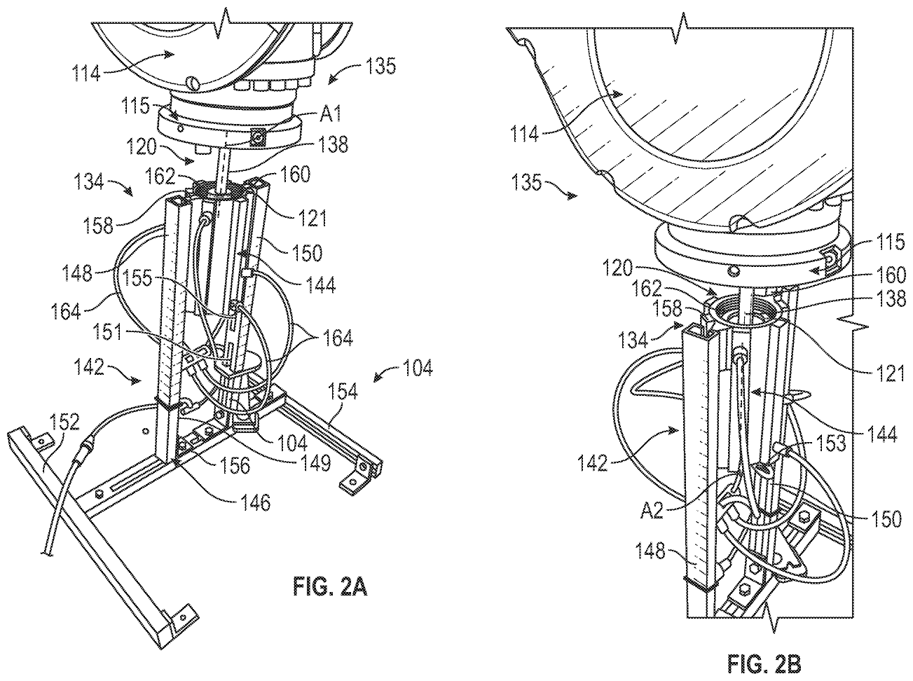

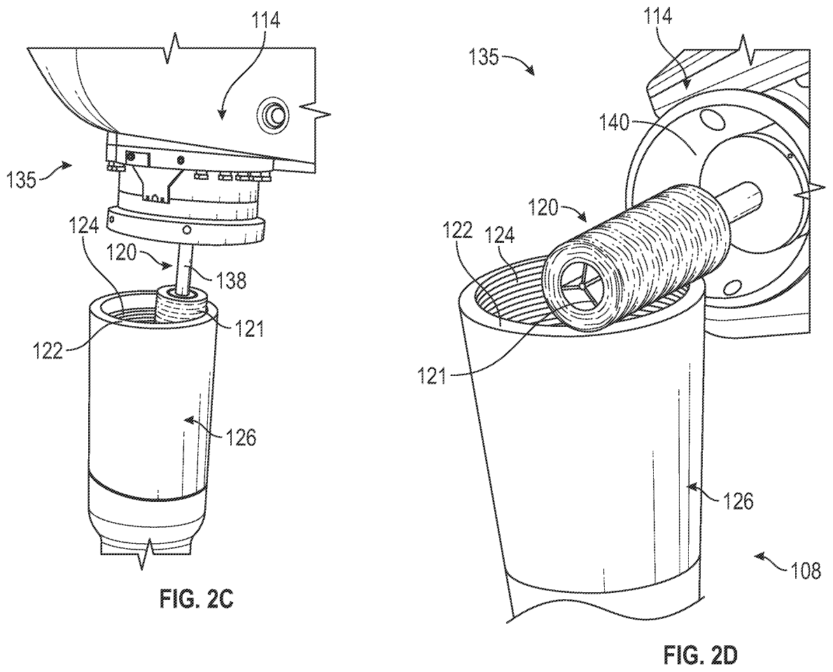

FIG. 1A illustrates a side perspective view of a drilling rig including a robotic system, according to one or more examples. FIG. 1B illustrates a perspective view of a robotic system with a pipe-dope application system, according to one or more examples. FIG. 2A illustrates a side view of the example robotic pipe-dope application system of FIG. 1B with a priming station in a first position, according to one or more examples. FIG. 2B illustrates a side view of the example robotic pipe-dope application system of FIG. 1B with a priming station in a second position FIG. 2B, according to one or more examples. Also shown in FIGS. 2A-2B is a first axis A1 and a second axis A2. FIG. 2C illustrates a side view of an example end effector of the robotic pipe-dope application system engaging a drill pipe engagement surface, according to one or more examples. FIG. 2D illustrates a side view of the end effector engaging a drill pipe end surface, according to one or more examples. FIGS. 1A-2D are discussed below concurrently.

Regarding FIGS. 1A-1B, the drilling rig 100 can be a mobile rig or stationary rig. The drilling rig 100 can be configured for onshore oil drilling, offshore oil drilling, or other types of drilling operations. The drilling rig 100 can include a robotic system 102, a drill floor 104 (FIG. 1A), and a mast 106 (FIG. 1A). The drill floor 104 can include a platform positioned above or over a well. The drill floor 104 can be configured to provide a working space for drilling operations and storage space for lengths of drill pipe or other equipment. The drill floor 104 can have an opening arranged at or near well center for accessing the well during drilling operations. The drill floor 104 can include a setback area 108 for storing drill pipes 110 (FIG. 1A). For example, the drill pipes 110 can be stored as single stands (e.g., a single length of drill pipe), or can be stored as double stands, triple stands, quadruple stands, or other sized stands positioned on end in the setback area 108.

The robotic system 102 be configured to perform, for example, but not limited to, stand building operations, trip in and trip out operations, pipe doping operations, or other operations. For example, the robotic system 102 can include a single robotic arm, such as the first robotic arm 112 shown in FIG. 1A (or the second robotic arm shown in FIG. 1B). In one example, the first robotic arm 112 can be located in the setback area 108. In other non-limiting examples, the first robotic arm 112 can be positioned near a mousehole (e.g., a hole or recessed area in the drill floor 104 where one of more of the drill pipes 110 can be stored), in a racking board on a catwalk (e.g., an elevated area located above the drill floor 104 for storing and aligning one or more of the drill pipes 110 with the drill string 118), or near storage areas for other threaded drilling components connectable to the drill pipes 110 or the drill string 118.

For example, such threaded drilling components can be, but are not limited to, drill string subs, such as lift subs, crossover subs, or top drive saver subs, or other threaded drilling tools. A lift sub is a threaded component useable to connect the drill string 118 to an assembly operable to lift the drill string 118, or a tool string for other down-bole operations. A crossover sub is a threaded component usable to connect lengths of pipe within the drill string 118 having different sizes or defining threads of differing characteristics. A top drive saver sub is a sacrificial threaded component used to connect a top drive to the drill string 118. The first robotic arm 112 can be adapted to manipulate a position and orientation of any of the drill pipes 110, such as by retrieving and holding a drill stand 116 (FIG. 1A) of the drill pipes 110, connecting the drill stand 116 to a drill string 118 extending into a well for trip in operations, connecting one or more of the drill pipes 110 to one another for stand building operations, or positioning any of the drill pipes 110 in a top drive of the drilling rig 100.

Further, the first robotic arm 112 can manipulate a position and orientation of an end effector 120 (FIG. 1B) containing an amount of pipe dope by moving an applicator 121 (FIG. 1B) of the end effector 120 along a drilling component engagement surface 122 or a drilling component end surface 124 of a box end 126 connected to the drill string 118, or of other various threaded drilling components; or along a drilling component engagement surface 128 (FIG. 1A) or a drilling component end surface 130 (FIG. 1A) of a pin end 132 (FIG. 1) connected to the drill stand 116, or of other various threaded drilling components. For example, the first robotic arm 112 can be configured to disengage an end effector configured for handling operations and engage the end effector 120 (FIG. 1B) to prepare the first robotic arm 112 for doping operations. The drilling component engagement surface 122 can be a first surface, such as a threaded portion of the box end 126 or a threaded portion of other threaded drilling components; and the drilling component engagement surface 128 can be a first surface, such as a threaded portion of the pin end 132 or a threaded portion of other threaded drilling components. The drilling component end surface 124 can be a second surface, such as a flat or planar surface of the box end 126 or other threaded drilling components, and the drilling component end surface 130 can be a second surface, such as a flat or planar surface of the pin end 132 or other threaded drilling components, extending orthogonally to the drilling component engagement surface 122 and the drilling component engagement surface 128, respectively.

In one non-limiting example, the robotic system 102 can include both the first robotic arm 112 and the second robotic arm 114. In such an example, the first robotic arm 112 can be configured to perform handling operations, such as by manipulating a position and orientation of any of the drill pipes 110, or other threaded drilling components, such as connecting the drill stand 116 to the drill string 118, connecting one or more of the drill pipes 110 or other threaded drilling components to one another, or positioning any of the drill pipes 110 or other threaded drilling components in a top drive of the drilling rig 100. The second robotic arm 114 can be configured to perform pipe dope application operations, such as by moving the end effector 120 along the drilling component engagement surface 122, the drilling component end surface 124, the drilling component engagement surface 128, or the drilling component end surface 130.

The first robotic arm 112, and in some examples, the second robotic arm 114, can be in communication with one or more feedback devices to provide information to the first robotic arm 112 and the second robotic arm 114, such as related to a position of the first robotic arm 112 relative to the second robotic arm 114, or vice versa, a position of the drill pipes 110 or the drill stand 116, the drill string 118, the end effector 120, or various other components of the drilling rig 100, such as a priming station 134 (FIGS. 2A-2D). The robotic system 102 can include at least one controller in communication with the feedback device. Such a controller can receive information provided by at least one feedback device to control operations of the first robotic arm 112 and the second robotic arm 114. Examples of pipe handling robots, feedback devices, and controllers, of which the first robotic arm 112 and the second robotic arm 114 can include any of various features or components thereof, are discussed in detail in United States Patent Publication No.: US2020-0040674A1, and United States Patent Publication No.: US2021-0301602A1, which are hereby incorporated by reference in their entirety.

Regarding FIGS. 2A-2B, the drilling rig 100 (FIG. 1A) can include a robotic pipe dope application system 135. In one non-limiting example, the robotic pipe dope application system 135 can include the second robotic arm 114, the end effector 120, and the priming station 134. The end effector 120 can include the applicator 121, a shaft member 138 defining the first axis A1, and a flange 140 (FIG. 2D). The applicator 121 can generally be a tubular or cylindrical body made from a material suitable to absorb or otherwise retain an amount of pipe dope. The flange 140 can be removably coupled to a distal portion 115 of the second robotic arm 114, such as to enable the first robotic arm 112 (FIG. 1A) or the second robotic arm 114 to change out various end effectors for different operations. For example, the distal portion 115 of the first robotic arm 112 or the flange 140 can include, or can otherwise be configured to interface with, any of the devices, systems, or methods described in International Patent Publication No.: WO2021/226622A1, which is hereby incorporated by reference in its entirety.

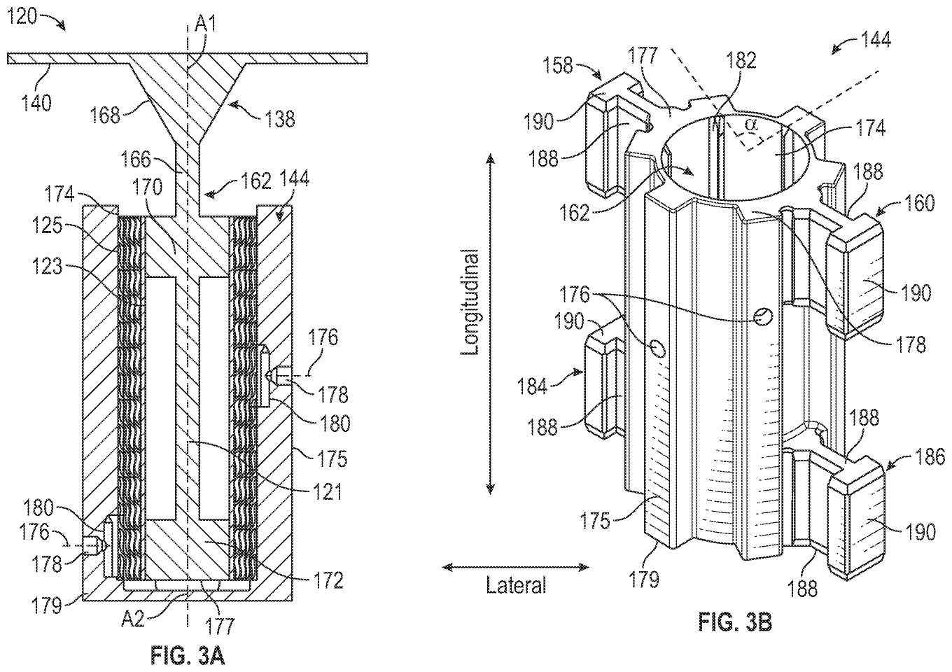

The applicator 121 can be removably connected to the shaft member 138, such as discussed below with reference to FIGS. 3A-3B. In one non-limiting example, the applicator 121 can be rotatably connected to the shaft member 138, such as to enable the applicator 121 to rotate around the shaft member 138 and the first axis A1. The priming station 134 can include a frame 142 and a receptacle 144. The frame 142 can include a base 146 (FIG. 2A), a first leg 148 (FIG. 2A), and a second leg 150 (FIG. 2A). The base 146 can include a first foot 152, a second foot 154, and a crossmember 156. The first foot 152 (FIG. 2A), the second foot 154 (FIG. 1A), the crossmember 156 can be, for example, but not limited to, one or more sections of flat, square, or rectangular bar stock, angle iron, tubular pipe, or other materials. The first foot 152 and the second foot 154 can extend along the drill floor 104. The crossmember 156 can coupled the first foot 152 to the second foot 154. In one non-limiting example, the crossmember 156 can extend orthogonally between the first foot 152 and the second foot 154 to couple the first foot 152 to the second foot 154. The first leg 148 and the second leg 150 can be coupled to, and extend vertically from, the crossmember 156, such as in positions spaced laterally apart relative to each other. For example, the first leg 148 and the second leg 150 can be spaced apart along the crossmember 156 by a lateral distance sufficient to enable the receptacle 144 to be positioned and supported therebetween.

The first leg 148 can define a first guide channel 149 (FIG. 2A) and the second leg 150 can define a second guide channel 151. The receptacle 144 can include a first guide projection 158 and a second guide projection 160. In an alternative example, the receptacle 144 can define the first guide channel 149 and the second guide channel 151, and the first leg 148 and the second leg 150 can include the first guide projection 158 and the second guide projection 160, respectively. The first guide projection 158 can extend into the first guide channel 149 of the first leg 148 and the second guide projection 160 can extend into the second guide channel 151 of the second leg 150. The first guide projection 158 and the second guide projection 160 can enable the receptacle 144 to translate longitudinally within the frame 142. The frame 142 can support the receptacle 144 above the drill floor 104.

For example, the first leg 148, or the second leg 150 can include a stop 153 (FIG. 2B) extending into or across the first guide channel 149 or the second guide channel 151 to contact and thereby limit translation of the first guide projection 158 or the second guide projection 160, such as to the second position shown in FIG. 2B. The first leg 148 or the second leg 150 can include one or more springs 155 (FIG. 2A). The one or more springs 155 can be positioned within the first guide channel 149, the second guide channel 151, or both, such as to contact the first guide projection 158 or the second guide projection 160 to bias the receptacle 144 upwardly within the frame 142 toward the first position.

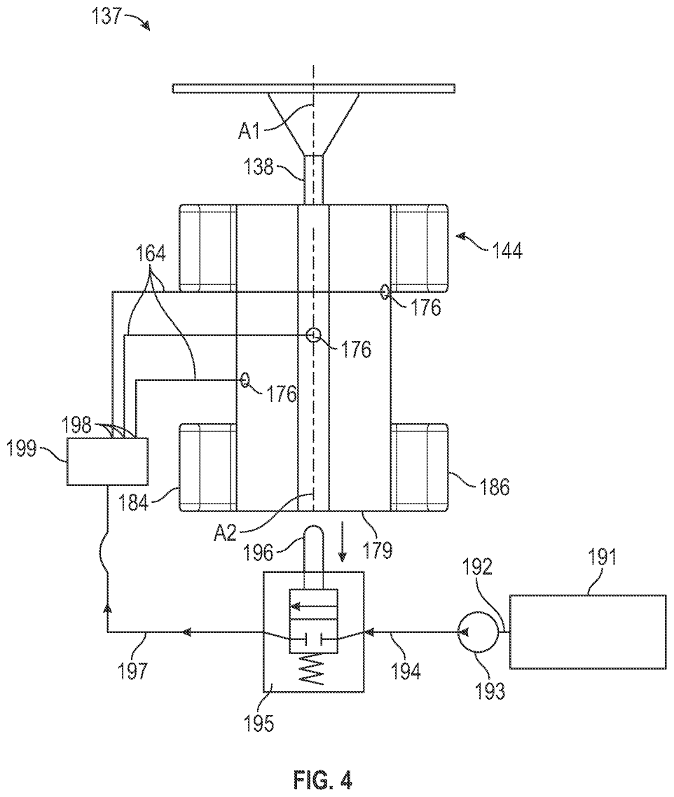

The receptacle 144 can define a receiving chamber 162 sized and shaped to receive the applicator 121. The receiving chamber 162 can define the second axis A2. When the applicator 121 is received within the receiving chamber 162, the first axis A1 defined by the shaft member 138 can be aligned with the second axis A2 defined by the receiving chamber 162. The robotic pipe dope application system 135 can include one or more supply lines 164 (FIG. 2A). The one or more supply lines 164 can be in fluid communication with the receiving chamber 162 and a pump system 137 (FIG. 4). The second robotic arm 114 can be configured to position the applicator 121 within the receiving chamber 162 of the receptacle 144. The priming station 134 can supply the applicator 121 with pipe dope. For example, the second robotic arm 114 can periodically position the applicator 121 within the receiving chamber 162 and translate the receptacle 144 from the first position shown in FIG. 2A to the second position shown in FIG. 2B. When the receptacle 144 is in the second position, the pump system 137 (FIG. 4) can pump pipe-dope into the receiving chamber 162 via the one or more supply lines 164.

Regarding FIGS. 2C-2D, in the operation of one non-limiting example, the first robotic arm 112 (FIG. 1A) can manipulate one of the drill pipes 110 (FIG. 1A) or the drill stand 116 (FIG. 1A) into a position accessible by the second robotic arm 114. In the operation of another non-limiting example, the first robotic arm 112 can be, or otherwise represent, a top drive, a robotic arm at a racking board, or drill floor robotic or non-robotic equipment adapted to hold or manipulate one or more of the drill pipes 110 or other threaded drilling components connectable to the drill stand 116 (FIG. 1A) or the drill string 118 (FIG. 1). The second robotic arm 114 can manipulate the end effector 120 to position the applicator 121 within the receiving chamber 162 (FIGS. 2A-2B) of the receptacle 144 (FIGS. 2A-2B). The second robotic arm 114 can apply an axial force to the receptacle 144 via the shaft member 138, to translate the receptacle 144, in a downward direction toward the drill floor 104 (FIG. 1A), from the first position to the second position within the frame 142 (FIGS. 2A-2B) to cause the pump system 137 (FIG. 4) to pump pipe dope into the receiving chamber 162 and onto the applicator 121 positioned therein, via the one or more supply lines 164.

While the receptacle 144 is maintained in the second position by the second robotic arm 114, the second robotic arm 114 can rotate the applicator 121 within the receiving chamber 162 to help distribute pipe dope more evenly along, or around, the applicator 121. The second robotic arm 114 can then lift the end effector 120 to allow the one or more springs 155 to return the receptacle 144 to the first position to cause the pump system 137 (FIG. 4) to stop pumping pipe dope into the receiving chamber 162 via the one or more supply lines 164. In some examples, the second robotic arm can continue rotating the applicator 121 within the receiving chamber 162 for a period of time, such as selected to help distribute pipe dope along, or around, the applicator 121. The second robotic arm 114 can then remove the applicator 121 from receptacle 144, and the one or more springs 155 can return the receptacle 144 to the first position to cause the pump system 137 (FIG. 4) to stop pumping pipe dope into the receiving chamber 162 via the one or more supply lines 164. The second robotic arm 114 can manipulate the end effector 120 to locate the applicator 121 proximal to, such as within, the box end 126 (FIGS. 1A-1B). The second robotic arm 114 can move the applicator 121 along the drilling component engagement surface 122, such as in a circular motion and angled to accommodate the tapered shape of the box end 126, in one example, to thereby apply pipe dope to the drilling component engagement surface 122 of the box end 126. The second robotic arm 114 can also move the applicator 121 along the drilling component end surface 124, such as in a linear motion, to thereby apply pipe dope to the drilling component end surface 124 of the box end 126.

The second robotic arm 114 can then manipulate the end effector 120 to locate the applicator 121 proximal to the pin end 132 (FIG. 1A). The second robotic arm 114 can move the applicator 121 along the drilling component engagement surface 128, such as in a circular motion and angled to accommodate the tapered shape of the pin end 132, for example, to apply pipe dope to the drilling component engagement surface 128 of the pin end 132. The second robotic arm 114 can also move the applicator 121 along the drilling component end surface 130, such as in a linear motion, to thereby apply pipe dope to the drilling component end surface 130 of the pin end 132.

Once both the pin end 132 and the box end 126 have received pipe dope from the applicator 121, the first robotic arm 112 (FIG. 1A) can connect or guide the pin end 132 into the box end 126. In some non-limiting examples, an iron roughneck, or other devices, can then be used to rotate the pin end 132 relative to the box end 126 to cause the drilling component engagement surface 122 and the drilling component engagement surface 128 to threadably engage one another to thereby establish a fluid tight seal between the drilling component engagement surface 122 and the drilling component engagement surface 128, and the drilling component end surface 124 and the drilling component end surface 130.

FIG. 3A illustrates a cross-section view of an example end effector 120 positioned within a receptacle 144. FIG. 3B illustrates an isometric view of an example receptacle 144. Also shown in FIGS. 3A-3B are orientation indicators Lateral and Longitudinal. FIGS. 3A-3B are discussed below concurrently with reference to FIGS. 1A-2D above. The applicator 121 (FIG. 3A) can include an inner surface 123 (FIG. 3A) and an outer surface 125 (FIG. 3A). In one non-limiting example, the inner surface 123 and the outer surface 125 can form a cylindrical or tubular shape. In other non-limiting examples, the inner surface 123 and the outer surface 125 can define other three-dimensional shapes, such as, but not limited to, triangular, rectangular, or hexagonal prisms. The outer surface 125 can be configured to retain an amount of pipe dope. For example, the outer surface 125 can made from a soft matrix material, such as, but not limited to, fleece, wool, bristle, sponge, or other materials capable of absorbing or otherwise retaining an amount of pipe dope.

The flange 140 (FIG. 3A) can form a planar or flattened shape. The flange 140 can be sized, shaped, or otherwise configured to engage with various styles of end effector couplers, such as defined by or attached to the distal portion 115 (FIGS. 2A-2D) of the second robotic arm 114. The shaft member 138 can include a body portion 166 (FIG. 3A) and a base portion 168 (FIG. 3A). The body portion 166 can define the first axis A1. The body portion 166 can be solid or tubular; or can form various three-dimensional shapes, such as, but not limited to, a cylinder, or a rectangular prism, a triangular prism, a hexagonal prism, or other three-dimensional shapes. The body portion 166 can be integrally formed with, or fixedly coupled to, the base portion 168.

The base portion 168 can connect the body portion 166 to the flange 140. The base portion 168 can help the shaft member 138 to resist lateral or other forces, such as applied by the second robotic arm 114 during doping operations. For example, the base portion 168 can be tapered, such as to define a greater circumference, width, or other dimension relative to the body portion 166 to strengthen the connection between the body portion 166 and the flange 140. The shaft member 138 can include a first protrusion 170 (FIG. 3A) and a second protrusion 172 (FIG. 3A). The first protrusion 170 and the second protrusion 172 can extend radially outward from the body portion 166.

The first protrusion 170 and the second protrusion 172 can be configured to retain the applicator 121. For example, the first protrusion 170 and the second protrusion 172 can be sized and shaped to contact and engage the inner surface 123 of the applicator 121 with a force of friction. Such a force of friction can be sufficient to prevent translation between the inner surface 123 and the first protrusion 170, or the second protrusion 172, during doping operations, while allowing a user to replace the applicator 121. For example, a user can translate the applicator 121 axially away from the flange 140 along the first axis A1 until the inner surface 123 disengages the first protrusion 170 and the second protrusion 172. In one non-limiting example, the first protrusion 170 and the second protrusion 172 can be rotatably connected to the body portion 166, such as to enable the applicator 121 to rotate freely around the body portion 166. In an alternative non-limiting example, the shaft member 138 and the inner surface 123 of the applicator 121 can be coupled to one another with other fastening means, such as, but not limited to, a detent, a snap fit, or one or more fasteners.

The receptacle 144 can include an inner surface 174, an outer surface 175, a top surface 177 (FIG. 3B), and bottom surface 179 (FIG. 3A). The receiving chamber 162 (FIG. 3B) can be defined by the inner surface 174. The receiving chamber 162 can extend through the top surface 177 and longitudinally within the receptacle 144 to, such as up, or otherwise near, the bottom surface 179. The receiving chamber 162 can be sized and shaped to conform, or otherwise correspond, to the outer surface 125 of the applicator 121. For example, the receiving chamber 162 define a diameter equal to or greater than a diameter defined by the outer surface 125 of the applicator 121. The receptacle 144 can define one or more fluid passages 176. The one or more fluid passages 176 can extend transversely between the inner surface 174 and the outer surface 175 of the receptacle 144. In one non-limiting example, the one or more fluid passages 176 can be cylindrical bores. In other non-limiting examples, each of the one or more fluid passages 176 can include a first portion 178 (FIG. 3A) and a second portion 180 (FIG. 3A).

The first portion 178 can be a bore or aperture defining various three-dimensional shapes, such as, but not limited to, a cylinder, or a rectangular prism, a triangular prism, a hexagonal prism, or other three-dimensional shapes. The first portion 178 of each of the one or more fluid passages 176 can be connected to one supply line of the one or more supply lines 164 (FIGS. 2A-2B). For example, the first portion 178 can define a plurality of threads, or can otherwise include a fitting, or other means, to fluidly connect the one or more supply lines 164 to the one or more fluid passages 176. The second portion 180 can be an oblong or elongated recess extending into the inner surface 174 of the receiving chamber 162. The second portion 180 can define various three-dimensional shapes, such as, but not limited to, an ellipsoidal, semi-spherical, or semi-cylindrical shape, a cuboidal prism, a rectangular prism, or other three-dimensional shapes. The second portion 180 can distribute pipe dope onto the outer surface 125 of the applicator 121.

The one or more fluid passages 176 can include various numbers of individual fluid passages. For example, the one or more fluid passages 176 can define, but is not limited to, one, two, three, four, five, six, seven, eight, nine, ten, eleven, or twelve individual fluid passages. Each of the one or more fluid passages 176 can be spaced longitudinally apart from an adjacent fluid passage of the one or more fluid passages 176, such as to help the one or more fluid passages 176 distribute pipe dope along the outer surface 125 of the applicator 121. For example, each of the one or more fluid passages 176 can be defined in different longitudinal positions relative to the second axis A2.

Each of the one or more fluid passages 176 can also be spaced radially apart from an adjacent fluid passage of the one or more fluid passages 176, such as to help the one or more fluid passages 176 distribute pipe dope around the applicator 121. For example, each of the one or more fluid passages 176 can be defined in the receptacle 144 equidistantly to one another in a radial arrangement. Angle α (FIG. 3B) can represent the radial spacing between each fluid passage of the one or more fluid passages 176. For example, if the one or more fluid passages 176 includes six fluid passages, the angle α can be about 60 degrees; and if the one or more fluid passages 176 includes four fluid passages, the angle α can be 90 degrees.

In one non-limiting example, each of the one or more fluid passages 176 can define a distribution channel 182 (FIG. 3B). The distribution channel 182 of each of the one or more fluid passages can generally form shapes, such as, but not limited to, a C channel or U channel shape. The distribution channel 182 of each of the one or more fluid passages 176 can extend radially outward, from the inner surface 174, into the receiving chamber 162. For example, the distribution channel 182 of each fluid passage of the one or more fluid passages 176 can extend longitudinally within the receiving chamber 162 parallel to, and laterally offset from, the second axis A2 (FIG. 3A) The distribution channel 182 of each of the one or more fluid passages 176 can enable pipe dope to be distributed along an entire longitudinal length or area of the outer surface 125 of the applicator 121. Additionally, when the second robotic arm 114 (FIGS. 2A-2D) is configured to rotate the applicator 121 within the receiving chamber 162, the distribution channel 182 of each of the one or more fluid passages 176 can press pipe dope into, and spread pipe dope along, the outer surface 125 of the applicator 121, such as to help uniformly and efficiently saturate the applicator 121 with pipe dope

In one non-limiting example, the receptacle 144 can include a third guide projection 184 (FIG. 3B) and a fourth guide projection 186 (FIG. 3B) in addition to the first guide projection 158 (FIG. 3B) and the second guide projection 160 (FIG. 3B). The first guide projection 158 and the second guide projection 160, and the third guide projection 184 and the fourth guide projection 186, can be radially offset by about 180 degrees relative to one another. The first guide projection 158, the second guide projection 160, the third guide projection 184, and the fourth guide projection 186 can each include a longitudinal portion 188 and a lateral portion 190. The longitudinal portion 188 can extend outwardly from the outer surface 175 of the receptacle 144. The longitudinal portion 188 can be configured, such as by being sized and shaped, to extend transversely through the first guide channel 149 (FIG. 2A) of the first leg 148 (FIGS. 2A-2B) or the second guide channel 151 (FIG. 2A) of the second leg 150 (FIGS. 2A-2B) of the frame 142 (FIGS. 2A-2B).

The lateral portion 190 can be received within the first guide channel 149 of the first leg 148 or the second guide channel 151 of the second leg of the frame 142. For example, the lateral portion 190 can be configured to contact and engage surfaces of the first leg 148 or the second leg 150 within the first guide channel 149 or the second guide channel 151. In one non-limiting example, the one or more springs 155 (FIG. 2A) of the frame 142 (FIGS. 2A-2B) can be positioned within the first guide channel 149, the second guide channel 151, or both, to contact the lateral portion 190 of the third guide projection 184 or the lateral portion 190 of the fourth guide projection 186 to bias the receptacle 144 upwardly within the frame 142 toward the first position. The longitudinal portion 188 and the lateral portion 190 can thereby collectively guide longitudinal translation of the receptacle 144 within the frame 142. The receptacle 144 can be made from various materials, for example, but not limited to, metals, ceramics, plastics, composites, such via molding, machining, or 3D printing.

FIG. 4 illustrates a schematic diagram of an example pump system 137 in fluid communication with a receptacle 144. FIG. 4 is discussed with reference to the FIGS. 1A-3B above. The pump system 137 can include a reservoir 191, a first line 192, a pump device 193, a second line 194, a valve 195, a third line 197, and a distribution manifold 199. The reservoir 191 can hold an amount of pipe dope. The reservoir 191 can be a conventional storage vessel, such as a bucket, or a proprietary storage vessel, such as sized and shaped to hold various amounts of pipe dope. The reservoir 191 can be a sealed, or otherwise covered, storage vessel to help prevent contamination of pipe dope.

The first line 192 can be a length of hard line, such as, but not limited to copper, steel, iron, polyvinyl chloride (PVC), or other types of rigid tubing; or a length of flexible line such as rubber, silicone, braided hose, or other types of flexible tubing. The first line 192 can fluidly connect the reservoir 191 to the pump device 193. The pump device 193 can be a low-pressure pump device, such as but not limited to, a pneumatic pump. The second line 194 can be a length of hard line, such as, but not limited to copper, steel, iron, polyvinyl chloride PVC), or other types of rigid tubing; or a length of flexible line such rubber, silicone, braided hose, or other types of flexible tubing. The second line 194 can fluidly connect the pump device 193 to the valve 195.

The valve 195 can be a control valve, such as but not limited to, a pneumatic control valve. The valve 195 can include a plunger 196. The plunger 196 can be translatable relative to the valve 195 to open or close the valve 195. The plunger 196 can be axially aligned with the first axis A1 or the second axis A2, or otherwise aligned with an axis extending parallel to, and laterally offset from, the first axis A1 and the second axis A1. The plunger 196 can be configured to open or close the valve 195 based on a position of the receptacle 144. In one non-limiting example, the plunger 196 can be positioned beneath the bottom surface 179 of the receptacle 144, such that the bottom surface 179 is proximal to, or in contact with, the plunger 196 when the receptacle 144 is in the first position. The bottom surface 179 can thereby depress the plunger 196 to open the valve 195 when the receptacle 144 translates from the first position the second position.

When the valve 195 is open, the pump device 193 can be configured to activate to extract pipe dope from the reservoir 191; and pump the pipe dope through the first line 192, the second line 194, and the valve 195. In another non-limiting example, the plunger 196 can be positioned with respect to the longitudinal portion 188 (FIG. 3B) or the lateral portion 190 (FIG. 3B) of the third guide projection 184 or the fourth guide projection 186, such that the third guide projection 184 or the fourth guide projection 186 can contact and depress the plunger 196 when the receptacle 144 translates from the first position to the second position. In view of the above, the amount of pipe dope delivered to the applicator 121 can be dictated by an amount of time that the second robotic arm 114 (FIGS. 2A-2D) maintains the receptacle 144 in the second position.

The third line 197 can be a length of hard line, such as, but not limited to copper, steel, iron, polyvinyl chloride (PVC), or other types of rigid tubing; or a length of flexible line such as rubber, silicone, braided hose, or other types of flexible tubing. The third line 197 can fluidly connect the valve 195 to the distribution manifold 199. The distribution manifold 199 can include one or more outlets 198. The one or more outlets 198 can be configured to engage the one or more supply lines 164. For example, the one or more outlets 198 can define a plurality of threads or include a fitting, or other fastening means, to establish fluid communication between each of the one or more supply lines 164 and each of the one or more outlets 198. The one or more outlets 198 can include a number of individual outlets proportional to a number of individual fluid passages of the one or more fluid passages 176 defined in the receptacle 144.

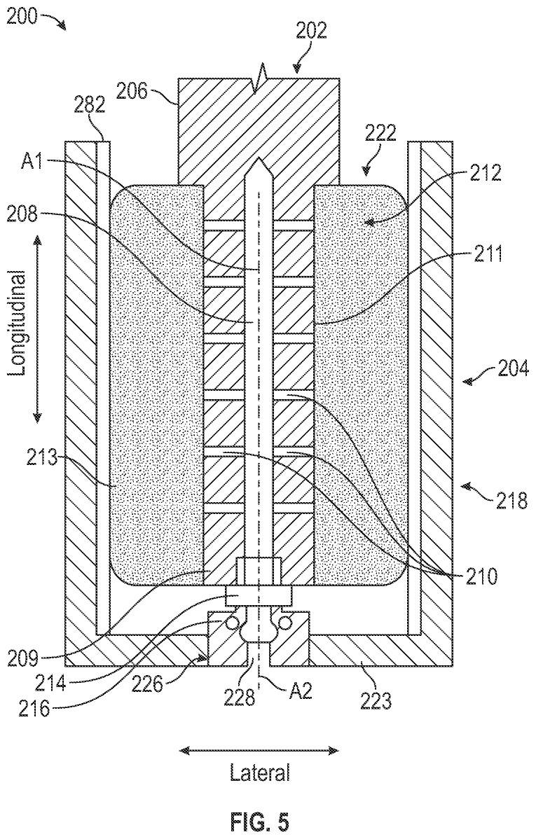

FIG. 5 illustrates a cross-section view of an example robotic pipe-dope application system 200. Also shown in FIG. 5 are orientation indicators Lateral and Longitudinal. The robotic pipe-dope application system 200 can include an end effector 202 and a priming station 204. The end effector 202 can be adapted for connection with the second robotic arm 114 shown in FIGS. 1A-2D. For example, the end effector 202 can include a shaft member 206. The shaft member 206 can be similar to the shaft member 138 (FIG. 3A) in that the shaft member 206 can be connected to the flange 140 (FIG. 3A), and thereby the second robotic arm 114 (FIGS. 2A-2D) via the base portion 168 (FIG. 3A). The shaft member 206 can define a first axis A1 In contrast to the shaft member 138, the shaft member 206 can define a longitudinal fluid passage 208 and a plurality of lateral fluid passages 210.

The longitudinal fluid passage 208 can extend axially through an end surface 209 of the shaft member 206 and at least partially through the shaft member 206 along the first axis A1. The longitudinal fluid passage 208 can form various three-dimensional shapes such as, but not limited to, a cylinder, a rectangular prism, a triangular prism, a hexagonal prism, or other three-dimensional shapes. Each of the plurality of lateral fluid passages 210 can extend laterally or radially outward from the longitudinal fluid passage 208 to an inner surface 211 of an applicator 212 of the end effector 202. The applicator 212, including the inner surface 211 and an outer surface 213, can be made from a soft matrix material, such as, but not limited to, fleece, wool, bristle, sponge, or other materials capable of absorbing or otherwise retaining an amount of pipe dope.

Each of the plurality of lateral fluid passages 210 can form various three-dimensional shapes such as, but not limited to, a cylinder, a rectangular prism, a triangular prism, a hexagonal prism, or other three-dimensional shapes. The plurality of lateral fluid passages 210 can include various numbers of individual lateral fluid passages. For example, the plurality of lateral fluid passages 210 can include one, two, three, four, five, six, seven, eight, nine, ten, eleven, twelve, thirteen, or fourteen individual lateral fluid passages. In one non-limiting example, such as shown in FIG. 5, the plurality of lateral fluid passages 210 can include twelve fluid passages.

Each of the plurality of lateral fluid passages 210 can be spaced longitudinally apart from an adjacent lateral fluid passage of the plurality of lateral fluid passages 210. For example, each of the plurality of lateral fluid passages 210 can be defined in different longitudinal positions relative to the first axis A1, such as to help the plurality of lateral fluid passages 210 distribute pipe dope along the applicator 212. Each of the plurality of lateral fluid passages 210 can also be spaced radially apart from an adjacent lateral fluid passage of the plurality of lateral fluid passages 210, such as to help the plurality of lateral fluid passages distribute pipe dope around the applicator 212. For example, each of the plurality of lateral fluid passages 210 can be spaced radially apart from an adjacent lateral fluid passage of the plurality of lateral fluid passages 210, by between, but not limited to, about 10 degrees to about 50 degrees, about 51 degrees to about 100 degrees, or about 101 to about 180 degrees.

The shaft member 206 can include a first dope fitting 214 and the priming station 204 can include a second dope fitting 216. The first dope fitting 214 can be, for example, but not limited to, a grease fitting such as grease zerk or grease nipple, or other types of fittings operable to transfer fluid therethrough. The first dope fitting 214 can be coupled to, and extend at least partially into, the longitudinal fluid passage 208. For example, the longitudinal fluid passage 208 can define a plurality of threads, include a fitting, or other fastening means configured to engage the first dope fitting 214 to couple to first dope fitting 214 to the shaft member 206.

The priming station 204 can include a receptacle 218. The receptacle 218 can define a receiving chamber 222 configured to receive the applicator 212. The receiving chamber 222 can be sized and shaped to conform, or otherwise correspond, to the outer surface 213 of the applicator 212. For example, the receiving chamber 222 define a diameter equal to or greater than a diameter defined by the outer surface 213 of the applicator 212. The receiving chamber 222 can define the second axis A2. When the applicator 212 is received within the receiving chamber 222, the first axis A1 defined by the shaft member 206 can be aligned with the second axis A2 defined by the receiving chamber 222.

In one non-limiting example, the receiving chamber 22 can define one or more distribution channels 282. The one or more distribution channels 282 can be similar to the distribution channel 182 shown in FIG. 3B, except in that the one or more distribution channels 282 are not in fluid communication with fluid passages. Accordingly, when the second robotic arm 114 (FIGS. 2A-2D) is configured to rotate the applicator 212 within the receiving chamber 222, the one or more distribution channel 282 can press pipe dope into, and spread pipe dope along, the outer surface 213 of the applicator 212, such as to help uniformly and efficiently saturate the applicator 212 with pipe dope.

The receptacle 218 can translate longitudinally in a downward direction, such as toward the drill floor 104, between a first position and a second position. For example, the receptacle 218 can be configured to engage with the frame 142 (FIGS. 2A-2B) by including the first guide projection 158, the second guide projection 160, the third guide projection 184, and the fourth guide projection 186. The receptacle 218 can include a second dope fitting 216 and an extension 226. The second dope fitting 216 and the extension 226 can extend into the receiving chamber 222, such as through a bottom surface 223 of the receptacle 218, along the second axis A2. The extension 226 can define or otherwise include the second dope fitting 216. For example, the second dope fitting 216 can be a fitting separate from the extension 226 and connected thereto, or the second dope fitting 216 can be an integral feature, such as an aperture or opening, of the extension 226. The extension 226 can define a supply passage 228. The supply passage 228 can extend longitudinally axially through the extension 226 and the second dope fitting 216. The supply passage 228 can be fluidly connected to the pump system 137 shown in FIG. 4.

For example, the supply passage 228 can be fluidly connected to the third line 197 (FIG. 4); and the plunger 196 (FIG. 4) of the valve 195 (FIG. 4) can be positioned beneath the bottom surface 223 of the receptacle 218, such that the bottom surface 223 is proximal to, or in contact with, the plunger 196 when the receptacle 218 is in the first position. The bottom surface 223 can thereby depress the plunger 196 to open the valve 195 when the receptacle 218 translates from the first position the second position. When the valve 195 is open, the pump device 193 can be configured to activate to extract pipe dope from the reservoir 191; and pump the pipe dope to the inner surface 211 of the applicator 212 through the first line 192, the second line 194, the valve 195, the third line 197, the supply passage 228, the second dope fitting 216, the first dope fitting 214, the longitudinal fluid passage 208, and the plurality of lateral fluid passages 210.

In one or more alternative examples, pipe dope may be supplied to the applicator 212 from the robot end, such as through the first robotic arm 112 (FIG. 1A) or the second robotic arm (FIG. 1B). That is, a fluid supply line of the first robotic arm 112 or the second robotic arm 114 can extend to the end effector 202, and depressing the applicator 212 within the receptacle 218 (e.g., moving the receptacle 218 from the first position to the second position) can open a valve on or within the end effector 202 to allow pipe doping material to flow into the supply passage 228 of the end effector 202. In either and/or both of the examples described above, the receptacle 218 can be used to distribute pipe dope about the outer surface 213 of the applicator 212 prior to applying pipe dope to a pin end and a box end of a drill pipe, or to similar surfaces of other threaded drilling components.

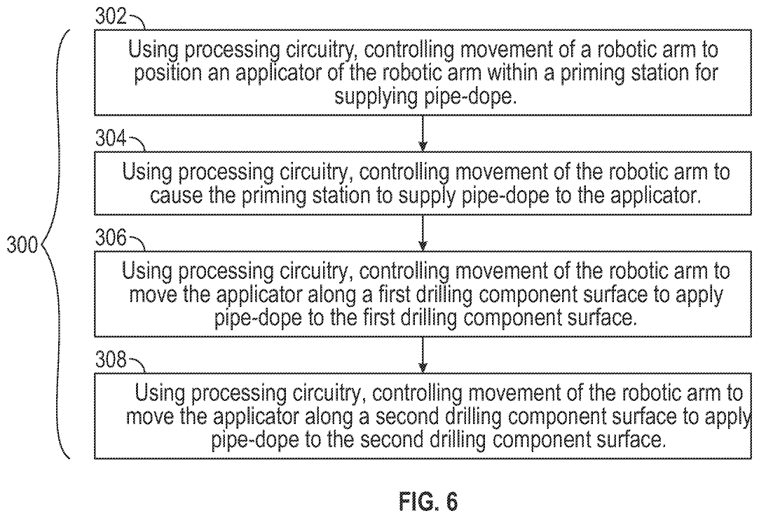

FIG. 6 illustrates an example method 300 of robotically applying pipe-dope to a drilling component surface. Any of the above examples of the pipe-dope application system 100-200 shown in, and described with regard to, FIGS. 1A-S above can be used in the method 300 of robotically applying pipe-dope to a drilling component surface. The discussed steps or operations can be performed in parallel or in a different sequence without materially impacting other operations. The method 300 as discussed includes operations that can be performed by multiple different actors, devices, and/or systems. It is understood that subsets of the operations discussed in the method 300 can be attributable to a single actor device, or system, and could be considered a separate standalone process or method.

The method 300 can include operation 302. The method 300 can include using processing circuitry, controlling movement of a robotic arm to position an applicator of the robotic arm within a priming station for supplying pipe-dope. For example, the robotic arm can be in communication with one or more feedback devices to provide information to the robotic arm to enable the robotic arm to locate, and thereby move the end effector relative to, the priming station and a receiving chamber defined therein. The method 300 can include operation 304. The operation 304 can include using processing circuitry, controlling movement of the robotic arm to cause the priming station to supply pipe-dope to the applicator. For example, the robotic arm can apply an axial force to the receptacle, via a shaft member of the end effector, to cause the receptacle to translate from a first position to a second position. Pipe dope can be continuously pumped into the receiving chamber of the receptacle and onto the applicator positioned therein, or through a shaft member of the end effector and onto the applicator, such as via a pumping system, when the receptacle is in the second position.

The method 300 can include operation 306. The operation 306 can include using processing circuitry, controlling movement of the robotic arm to move the applicator along a first drilling component surface to apply pipe-dope to the first drilling component surface. For example, the robotic arm can be in communication with one or more feedback devices to provide information to the robotic arm to enable the robotic arm to locate, and thereby move the end effector relative to, a drilling component engagement surface of a box end of drill pipe, or a drilling component engagement surface of various threaded drilling components; or a drilling component engagement surface of a pin end of a drill pipe, or a drilling component engagement surface of various threaded drilling components.

The method 300 can optionally include operation 308. The operation 308 can include using processing circuitry, controlling movement of the robotic arm to move the applicator along a second drilling component surface to apply pipe-dope to the second drilling component surface. For example, the robotic arm can be in communication with one or more feedback devices to provide information to the robotic arm to enable the robotic arm to locate, and thereby move the end effector relative to, a drilling component end surface of a box end of a drill pipe, or a drilling component end surface of various threaded drilling components; or a drilling component end surface of pin end of a drill pipe, or a drilling component end surface of various threaded drilling components.

In one non-limiting example, the method 300 can includes rotating the applicator within a receiving chamber of the receptacle. For example, the robotic arm can be programmed to rotate a shaft member connected to the applicator around a first axis or a second axis when the applicator is positioned within the receiving chamber, such as to help the priming station distribute pipe dope around or along the applicator.

The foregoing systems and devices, etc. are merely illustrative of the components, interconnections, communications, functions, etc. that can be employed in carrying out examples in accordance with this disclosure. Different types and combinations of sensor or other portable electronics devices, computers including clients and servers, implants, and other systems and devices can be employed in examples according to this disclosure.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventor also contemplates examples in which only those elements shown or described are provided.

Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein. In the event of inconsistent usages between this document and any documents so incorporated by reference, the usage in this document controls.

Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein. In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure.

This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

### EXAMPLES

The following, non-limiting examples, detail certain aspects of the present subject matter to solve the challenges and provide the benefits discussed herein, among others.

Example 1 is a pipe-dope application system comprising: an end effector including an applicator configured to retain pipe-dope for application to a drilling component surface, the end effector adapted for connection with a robotic arm configured to perform operations including: applying pipe-dope to the drilling component surface by moving the applicator along the drilling component; and supplying pipe-dope to the applicator by positioning the applicator within a priming station configured to receive the applicator of the end effector.

In Example 2, the subject matter of Example 1 includes, a priming station including: a frame; and a receptacle supported within the frame and defining an receiving chamber configured to receive the applicator, the receptacle translatable between a first position and a second position, wherein: the priming station is configured to distribute pipe-dope to the applicator when the receptacle is in the second position; and the robotic arm is configured to translate the receptacle from the first position to the second position.

In Example 3, the subject matter of Example 2 includes, a pump system in fluid communication with the receiving chamber of the receptacle, the pump system configured to pump pipe-dope into the receiving chamber when the receptacle is in the second position.

In Example 4, the subject matter of Examples 2-3 includes, wherein the priming station includes a spring positioned within the frame, the spring configured to contact the receptacle to bias the receptacle toward the first position.

In Example 5, the subject matter of Examples 3-4 includes, wherein the end effector includes a shaft member adapted for connection with the robotic arm; and wherein the applicator is rotatably connected to the shaft.

In Example 6, the subject matter of Example 5 includes, wherein the receptacle includes: an outer surface; an inner surface defined within the receiving chamber, the receiving chamber extending longitudinally through the receptacle between a top surface and bottom surface; and one or more fluid passages extending transversely between the outer surface and the inner surface, the one or more fluid passages configured to distribute pipe-dope to the applicator from the pump system.

In Example 7, the subject matter of Example 6 includes, wherein the frame includes a first guide projection and a second guide projection, the first guide projection and the second guide projection extending inwardly from a first leg and a second leg of the frame, respectively; and wherein the first guide projection and the second guide projection are partially received within a first guide channel and a second guide channel defined by the receptacle, respectively, to guide longitudinal translation of the receptacle within the frame between the first position and the second position.

In Example 8, the subject matter of Examples 6-7 includes, wherein the receptacle includes a first guide projection and a second guide projection, the first guide projection and the second guide projection extending radially outward from the outer surface of the receptacle; and wherein the first guide projection and the second guide projection are partially received within a first guide channel and a second guide channel of the frame, respectively, to guide longitudinal translation of the receptacle within the frame between the first position and the second position.

In Example 9, the subject matter of Examples 6-8 includes, wherein the pump system includes: a reservoir configured to hold a supply of pipe-dope; a pump device in fluid communication with the reservoir, the pump device configured to pump pipe dope from the reservoir to a valve including a plunger configured to open the valve when the receptacle is in the second position; a distribution manifold configured to distribute pipe-dope from the valve to one or more supply lines, wherein the one or more supply lines fluidly connect the distribution manifold to the one or more fluid passages of the receptacle.

In Example 10, the subject matter of Example 9 includes, wherein each of the one or more fluid passages defines a distribution channel extending radially outward from the inner surface of the receptacle into the receiving chamber, the distribution channels extending longitudinally within the receiving chamber parallel to and laterally offset from a second axis.

In Example 11, the subject matter of Example 10 includes, wherein the robotic arm is configured to rotate the applicator around a first axis or the second axis when the applicator is positioned within the receptacle.

Example 12 is a robotic pipe-dope application system comprising: an end effector including: an applicator configured to retain pipe-dope for application to a drilling component surface; a shaft member extending through the applicator and configured to fluidly connect an inner surface of the applicator to a pump system, the shaft member adapted for connection with a robotic arm configured to perform operations including: applying pipe-dope to the drilling component surface by moving the applicator along the drilling component surface; and supplying pipe-dope to the applicator by positioning the applicator within a priming station configured to receive the applicator of the end effector and in fluid communication with the pump system.

In Example 13, the subject matter of Example 12 includes, wherein the shaft member defines a longitudinal fluid passage extending axially through an end surface of the shaft member, and a plurality of lateral fluid passages extending between the inner surface of the applicator and the longitudinal fluid passage, the plurality of lateral fluid passages configured to distribute pipe-dope to the applicator from the pump system via the longitudinal fluid passage.

In Example 14, the subject matter of Example 13 includes, wherein the priming station includes: a receptacle defining a receiving chamber configured to receive the applicator, the receptacle translatable between a first position and a second position, wherein: the priming station is configured to distribute pipe-dope to the longitudinal fluid passage of the shaft member when the receptacle is in the second position; and the robotic arm is configured to translate the receptacle from the first position to the second position.

In Example 15, the subject matter of Example 14 includes, wherein the receptacle includes one or more distribution channels extending radially outward from an inner surface of the receptacle into the receiving chamber, the one or more distribution channels extending longitudinally within the receiving chamber parallel to and laterally offset from a second axis; and wherein the robotic arm is configured to rotate the applicator around a first axis or the second axis when the applicator is positioned within the receptacle.

In Example 16, the subject matter of Example 15 includes, wherein the pump system includes: a reservoir configured to hold a supply of pipe-dope; a pump device in fluid communication with the reservoir, the pump device configured to pump pipe dope from the reservoir to a valve configured to open when the receptacle is in the second position; and a supply passage fluidly connecting the valve to a supply passage of the receptacle, the supply passage configured to interface with the longitudinal fluid passage when the end effector is received within the receiving chamber to establish fluid communication therebetween.

Example 17 is a method of robotically applying pipe-dope to a drilling component surface, the method comprising: using processing circuitry, controlling movement of a robotic arm to position an applicator of the robotic arm within a priming station for supplying pipe-dope; using processing circuitry, controlling movement of the robotic arm to cause the priming station to supply pipe-dope to the applicator; and using processing circuitry, controlling movement of the robotic arm to move the applicator along a first drilling component surface to apply pipe-dope to the first drilling component surface.

In Example 18, the subject matter of Example 17 includes, wherein controlling movement of the robotic arm to cause the priming station to supply pipe-dope to the applicator includes translating a receptacle of the priming station from a first position to a second position.

In Example 19, the subject matter of Example 18 includes, wherein the method includes rotating the applicator within a receiving chamber of the receptacle.

In Example 20, the subject matter of Examples 17-19 includes, wherein the method further comprises, using processing circuitry, controlling movement of the robotic arm to move the applicator along a second drilling component surface to apply pipe-dope to the second drilling component surface.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A pipe-dope application system comprising:
an end effector including an applicator configured to retain pipe-dope for application to a drilling component surface, the end effector adapted for connection with a robotic arm configured to perform operations including:
applying pipe-dope to the drilling component surface by moving the applicator along the drilling component; and
supplying pipe-dope to the applicator by positioning the applicator within a priming station configured to receive the applicator of the end effector.

2. The system of claim 1, further comprising a priming station including:
a frame; and
a receptacle supported within the frame and defining an receiving chamber configured to receive the applicator, the receptacle translatable between a first position and a second position, wherein:
the priming station is configured to distribute pipe-dope to the applicator when the receptacle is in the second position; and
the robotic arm is configured to translate the receptacle from the first position to the second position.

3. The system of claim 2, further comprising a pump system in fluid communication with the receiving chamber of the receptacle, the pump system configured to pump pipe-dope into the receiving chamber when the receptacle is in the second position.

4. The system of claim 2, wherein the priming station includes a spring positioned within the frame, the spring configured to contact the receptacle to bias the receptacle toward the first position.

5. The system of claim 3, wherein the end effector includes a shaft member adapted for connection with the robotic arm; and wherein the applicator is rotatably connected to the shaft.

6. The system of claim 5, wherein the receptacle includes:
an outer surface;
an inner surface defined within the receiving chamber, the receiving chamber extending longitudinally through the receptacle between a top surface and bottom surface; and
one or more fluid passages extending transversely between the outer surface and the inner surface, the one or more fluid passages configured to distribute pipe-dope to the applicator from the pump system.

7. The system of claim 6, wherein the frame includes a first guide projection and a second guide projection, the first guide projection and the second guide projection extending inwardly from a first leg and a second leg of the frame, respectively; and wherein the first guide projection and the second guide projection are partially received within a first guide channel and a second guide channel defined by the receptacle, respectively, to guide longitudinal translation of the receptacle within the frame between the first position and the second position.

8. The system of claim 6, wherein the receptacle includes a first guide projection and a second guide projection, the first guide projection and the second guide projection extending radially outward from the outer surface of the receptacle; and wherein the first guide projection and the second guide projection are partially received within a first guide channel and a second guide channel of the frame, respectively, to guide longitudinal translation of the receptacle within the frame between the first position and the second position.

9. The system of claim 6, wherein the pump system includes:
a reservoir configured to hold a supply of pipe-dope;
a pump device in fluid communication with the reservoir, the pump device configured to pump pipe dope from the reservoir to a valve including a plunger configured to open the valve when the receptacle is in the second position;
a distribution manifold configured to distribute pipe-dope from the valve to one or more supply lines, wherein the one or more supply lines fluidly connect the distribution manifold to the one or more fluid passages of the receptacle.

10. The system of claim 9, wherein each of the one or more fluid passages defines a distribution channel extending radially outward from the inner surface of the receptacle into the receiving chamber, the distribution channels extending longitudinally within the receiving chamber parallel to and laterally offset from a second axis.

11. The system of claim 10, wherein the robotic arm is configured to rotate the applicator around a first axis or the second axis when the applicator is positioned within the receptacle.

12. A robotic pipe-dope application system comprising:
an end effector including:
an applicator configured to retain pipe-dope for application to a drilling component surface;
a shaft member extending through the applicator and configured to fluidly connect an inner surface of the applicator to a pump system, the shaft member adapted for connection with a robotic arm configured to perform operations including:
applying pipe-dope to the drilling component surface by moving the applicator along the drilling component surface; and
supplying pipe-dope to the applicator by positioning the applicator within a priming station configured to receive the applicator of the end effector and in fluid communication with the pump system.

13. The system of claim 12, wherein the shaft member defines a longitudinal fluid passage extending axially through an end surface of the shaft member, and a plurality of lateral fluid passages extending between the inner surface of the applicator and the longitudinal fluid passage, the plurality of lateral fluid passages configured to distribute pipe-dope to the applicator from the pump system via the longitudinal fluid passage.

14. The system of claim 13, wherein the priming station includes:
a receptacle defining a receiving chamber configured to receive the applicator, the receptacle translatable between a first position and a second position, wherein:
the priming station is configured to distribute pipe-dope to the longitudinal fluid passage of the shaft member when the receptacle is in the second position; and
the robotic arm is configured to translate the receptacle from the first position to the second position.

15. The system of claim 14, wherein the receptacle includes one or more distribution channels extending radially outward from an inner surface of the receptacle into the receiving chamber, the one or more distribution channels extending longitudinally within the receiving chamber parallel to and laterally offset from a second axis; and wherein the robotic arm is configured to rotate the applicator around a first axis or the second axis when the applicator is positioned within the receptacle.

16. The system of claim 15, wherein the pump system includes:
a reservoir configured to hold a supply of pipe-dope;
a pump device in fluid communication with the reservoir, the pump device configured to pump pipe dope from the reservoir to a valve configured to open when the receptacle is in the second position; and
a supply passage fluidly connecting the valve to a supply passage of the receptacle, the supply passage configured to interface with the longitudinal fluid passage when the end effector is received within the receiving chamber to establish fluid communication therebetween.

17. A method of robotically applying pipe-dope to a drilling component surface, the method comprising:
using processing circuitry, controlling movement of a robotic arm to position an applicator of the robotic arm within a priming station for supplying pipe-dope;
using processing circuitry, controlling movement of the robotic arm to cause the priming station to supply pipe-dope to the applicator; and
using processing circuitry, controlling movement of the robotic arm to move the applicator along a first drilling component surface to apply pipe-dope to the first drilling component surface.

18. The method of claim 17, wherein controlling movement of the robotic arm to cause the priming station to supply pipe-dope to the applicator includes translating a receptacle of the priming station from a first position to a second position.

19. The method of claim 18, wherein the method includes rotating the applicator within a receiving chamber of the receptacle.

20. The method of claim 17, wherein the method further comprises, using processing circuitry, controlling movement of the robotic arm to move the applicator along a second drilling component surface to apply pipe-dope to the second drilling component surface.
